(19) United States
(12) Patent Application Publication
(10) Pub. No.: US 2024/0392949 A1
(43) Pub. Date: Nov. 28, 2024

(54) OPTICAL DESIGN FOR REFLECTIVE LUMINAIRE

(71) Applicant: Luminii LLC, Niles, IL (US)

(72) Inventors: Peter Kozodoy, Palo Alto, CA (US); John Lloyd, Portsmouth, RI (US)

(21) Appl. No.: 18/795,459

(22) Filed: Aug. 6, 2024

Related U.S. Application Data
(62) Division of application No. 17/554,726, filed on Dec. 17, 2021.
(60) Provisional application No. 63/128,155, filed on Dec. 20, 2020.

(51) Int. Cl. F21V 13/04; F21V 5/04; F21V 7/00

(52) U.S. Cl. CPC F21V 13/04; F21V 5/045; F21V 5/048; F21V 7/0008; F21V 7/005

(57) ABSTRACT

An optical system, such as may be used in directional luminaires. Engineered diffusion and tailoring of the components of the system corrects undesirable artifacts in the projected beam.

### CROSS REFERENCE TO RELATED APPLICATIONS

This application is a divisional of co-pending U.S. patent application Ser. No. 17/554,726 filed Dec. 17, 2021, which claims priority to U.S. Provisional Application Ser. No. 63/128,155 filed Dec. 20, 2020, the entire contents of each of which are hereby incorporated by reference.

### TECHNICAL FIELD

The present invention relates to optics, specifically to optical structures for lighting products.

### BACKGROUND

Light sources for illumination purposes, such as light emitting diodes (LEDs), incandescent or halogen lamps, emit visible radiation in a broad range of angles. In lighting applications for many purposes this broad distribution of light is undesirable and directional light is needed. Lighting fixtures that collimate and direct illumination in specific directions are highly advantageous.

This task is typically accomplished with luminaires utilizing a light engine (including a light emitting source, circuitry to provide power, and often a heat sink to dissipate waste heat) and an optical system including one or more reflective or refractive optics to collimate, shape, and mix the light output into a desirable light distribution. The light engine and optics are typically fixed in position relative to each other, and the entire assembly is then tilted by various mechanical means in order to direct the light beam. The combined size and mass of the optical system along with the light engine presents numerous challenges, including placing directional lights in confined spaces or in close proximity to each other. In addition, the aesthetic impact of a multitude of directional lights aimed in different directions is often considered unappealing.

A known alternative to these traditional adjustable luminaires is to exploit imaging optics to collimate and aim a bright source. Systems utilizing this design have been shown in prior art using backward-firing light sources (aimed into the luminaire) coupled with reflective lenses. Beam steering is achieved by controlling in-plane displacement of the light source relative to the optical axis of the lens. Non-steering implementations of this type of optical system design are also valuable.

FIG. 1 shows an example back-firing optical system of prior art, comprising a light emitting source 100 (such as an undomed LED) and a reflective lens optic 180. The reflective lens optic 180 in this prior art embodiment is a solid optic (or “lens”) 104 made of transparent material with refractive index>1. The solid optic 104 comprises a front face 102, an interior region 103, and a rear face 106. A reflective coating 107 is disposed on the rear face 106 and is conformal to its contours. The light source 100 is supported on a support structure 110 that provides electrical connection to the light source 100 and conducts heat away from the light source 100. The support structure 110 may, for example, be a portion of a metal-core printed circuit board. It necessarily obscures a portion of the front face 102 of the optic 104, and may be shaped in various ways to minimize this obscuration.

Light 101 from the source 100 enters the front face 102, transits through the optic interior 103 to strike the reflective coating 107 disposed on the rear face 106, then transits through the optic interior 103 again before exiting the face 102 to form the output beam 108. The direction of the output beam 108 may be controlled by adjusting the position of the light source 100 relative to the optical axis 105 of the solid optic 104, within the plane perpendicular to the optical axis 105. The solid optic 104 may be described as a “second-surface reflector” (SSR) because the optical reflection of interest occurs at the interface between the lens interior 103 and the reflective coating 107 disposed on the rear face 106.

Several optical challenges limit the performance of this optical system of prior art, and of steerable luminaires that use such optical systems.

First, imaging the source 100 in the projected beam 108 imparts into the beam 108 any spatial non-uniformity of intensity or color present in the source 100. Additionally, the shape of the source 100 may be square or rectangular, while the beam may be desired to be circular or oval. For these reasons, an optical design is needed that can introduce limited mixing and diffusion of the beam within the optical system.

Second, it is desirable to offer lighting products with a variety of different beam widths in order to serve different lighting purposes. A simple optical mechanism is needed in order to provide enlarged beam widths without otherwise changing the design or operation of the luminaire and its optical system.

Third, light emitted from the light emitting source at very high angles (for example, above 75° relative to the optical axis) is not efficiently collected by the optical system and can result in unwanted glare. Collimating optics such as total internal reflection (TIR) collimators are widely used in LED illumination to collect the broad angular emission from a light source and direct it into a narrower beam. But these optics are necessarily large, generally several times deeper and wider than the light source is wide. Such a large optic would introduce substantial beam shadowing and/or beam shape artifacts if incorporated onto to the light source in the backfiring optical system. What is needed is a compact optic for moderate collimation in backfiring optical system.

Fourth, coma aberrations occur as the output beam 108 is steered away from the optical axis 105. This results in broadening of the beam in the steered direction, causing an asymmetrical beam shape. What is needed is an optical design that minimizes coma aberration.

Fifth, optical dispersion in the material of the solid optic causes different colors of light to be steered to different degrees. This results in color separation in beams that are steered away from the optical axis 105, with light towards the blue end of the optical spectrum being steered further than light toward the red end of the optical spectrum. This color separation can cause undesirable color effects at the edges of the steered beam. What is needed is an optical design that counteracts color separation.

Sixth, it is difficult to form a second-surface reflector coating with both high reflectivity and high durability on certain materials. Practical designs must therefore compromise between the desired properties for the optical material of the solid optic 104 (such as low cost, high transparency, and low optical dispersion) and optimal performance of the reflective coating 107. What is needed is a variation on the optical design that preserves the functionality of prior art but avoids such tradeoffs.

Finally, there are optical impacts that result from the support structure 110 obscuring a portion of the output beam 108. Shadowing by the support structure results in lost light, substantially reducing the optical efficiency of the system. In addition, when the support structure is brightly lit by the output beam 108 it will itself be imaged in the optical system and projected as part of the output beam, which can create undesirable beam shape. Finally, the sidewalls 111 of the support structure 110 can reflect and scatter light in the output beam 108. Scattered light creates undesirable glare in the system, and specular reflections off the sidewall 111 can produce reflected beams pointed in directions that are not intended for illumination.

In the directional luminaire optics to which these optical structures pertain, light emitted from the light emitting source at very high angles (>75°) relative to the optical axis is generally not efficiently collected by the optical system and can result in unwanted glare. For flat light emitting sources this high-angle light may be a small fraction of the total luminous output, but it can be an undesirable source of glare, and it would be advantageous to either collimate it and direct it into the imaging optical system, reflect it back into the light emitting source for possible recycling, or absorb it.

### SUMMARY

The backfiring optical systems for directional luminaires described herein provide engineered diffusion and tailoring of the beam to correct undesirable artifacts.

In one embodiment a back-firing optical system comprises a light source, a solid lens having an entry face and a back face, and a surface reflector. The surface reflector is disposed in close proximity to the lens, and spaced apart from the back face of the lens by an air gap. The surface reflector features an overall curvature that conforms to the an overall curvature of the rear or back face of the lens.

A support structure may be provided. The support structure has a face oriented towards the front face of the lens. The face of the support structure may be further composed of light-absorbing material, thereby reducing an extent to which the support structure is imaged in an output beam. Alternatively, the face of the support structure may have a reflective area thereon. The reflective area may have (a) a shape that imparts a change in intensity distribution of the output beam or (b) a specific reflectivity spectrum to produce a shift in the spectrum of the output beam.

The lens and surface reflector may form an optical element that is part of an array of optical elements.

An adjuster mechanism may be arranged to move an axis of the optical elements with respect to an axis of the light source to effect steering of the output beam.

### BRIEF DESCRIPTION OF DRAWINGS

FIG. 1 shows a cross-section view of a back-firing optical system of prior art.

FIG. 2 shows a cross-section view of a reflective lens with a faceted rear face.

FIG. 3 shows a cross section view of a reflective lens with a uniformly-textured rear face.

FIG. 4 shows a perspective view of a two-unit reflective-lens piece designed for integration into a lighting fixture.

FIG. 5 shows a cross-section view of a reflective lens with texture that decreases with radial distance from the lens optical axis.

FIG. 6 shows schematically the beam profile changes from using reflective lenses with smooth vs. uniformly textured vs. radially-decreasing textured rear faces, for both centered and steered-beams.

FIG. 7 shows a cross-section view of a reflective lens with randomly-perturbed lenslet positions.

FIG. 8A to FIG. 8D show cross-section views of four designs of a doublet reflective lens.

FIG. 9 shows a cross-section view of a doublet reflective lens with an airgap.

FIG. 10 shows a cross-section view of a doublet reflective lens with a textured rear face.

FIG. 11 shows a cross-section view of a reflective lens ensemble that uses a FSR (first-surface reflector) piece.

FIG. 12 shows a cross-section view of a reflective lens ensemble that uses a FSR (first-surface reflector) piece with a high-reflectivity coating.

FIG. 13 shows a cross-section view of a reflective lens ensemble that uses a FSR (first-surface reflector) piece and features texture on the lens element and a smooth FSR surface.

FIG. 14 shows a cross-section view of a reflective lens ensemble that uses a FSR (first-surface reflector) piece and features texture on the FSR surface and a smooth lens element rear face.

FIG. 15A shows a cross-section view of a lenticular optical pair consisting of a lens element with a textured rear face and a FSR with a textured surface.

FIG. 15B shows a plot of beam width vs. relative rotation for an example back-firing optical system with a lenticular optical pair.

FIG. 16 shows a cross-section view of a reflective lens with an anti-reflective layer on the entry face.

FIG. 17 shows a cross-section view of a back-firing optical system with a solid collimator on the light-source.

FIG. 18 shows a cross-section view of a back-firing optical system with a solid collimator on the light-source that features a reflective tube surrounding the light source sidewalls.

FIG. 19 shows a cross-section view of a back-firing optical system with a hollow collimator on the light-source.

FIG. 20 shows a cross-section view of a back-firing optical system with a plano-convex lens collimator on the light-source.

FIG. 21 shows a cross-section view of a back-firing optical system with a hollow reflector and a collimator on the light-source.

FIG. 22 shows a cross-section view of a back-firing optical system with a support-structure that is colored in order to be light-absorbing on the surface and sidewalls.

FIG. 23 shows a cross-section view of a back-firing optical system with a support-structure that is reflective in the area immediately surrounding the light source.

FIG. 24 shows a cross-section view of a back-firing optical system with a support-structure that is reflective in an area with a designed size and shape.

FIG. 25A to 25C shows a plan view of an array of reflective lenses and a matched array of light sources, with the arrays oriented to produce (a) a centered beam, (b) a steered beam, and (c) a broadened beam.

FIG. 26 shows a plan view of an array of reflective lenses and a corresponding array of light sources, where the positioning of the light sources in the light source array does not match the positioning of the reflective lenses in the reflective lens array so that the light beams from the individual lenses are not all identically aimed.

FIG. 27A and FIG. 27B show a plan view of an array of reflective lenses and a corresponding array of light sources, where the position of the light sources relative to the lenses may be independently adjusted in order to independently steer the light beams from the different reflective lens elements.

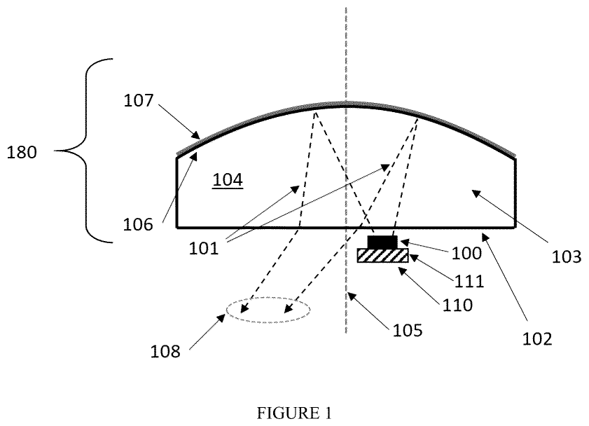

### DESCRIPTION OF THE ONE OR MORE EMBODIMENTS

### 1. Surface Texturing of SSR

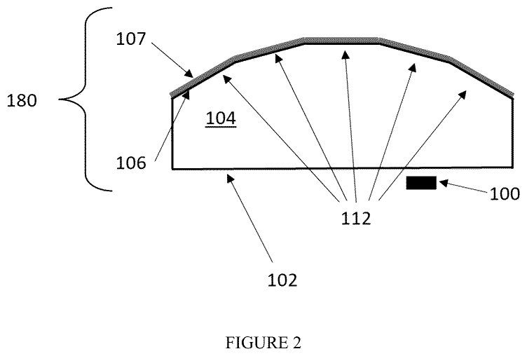

One method to design the reflective lens 180 in such a manner as to blend, enlarge, or shape the source illumination into a uniform beam is to deviate the reflective lens profile from a smooth lens formula that provides imaging qualities. FIG. 2 depicts this as accomplished via flat facets 112 applied to the rear face profile 106. The reflective coating 107 is conformal to the facets 112. The faceting should be designed so as not to impart new artifacts into the projected beam, particularly as the source is translated to steer the beam. Through the laws of refraction and reflection, the size of facets can be determined according to the maximum tolerable deviation between the surface angle of the flat facet and the surface angle of the lens formula for any position of the source within the steering range. This calculation allows the non-imaging expansion of the beam resulting from the faceting to remain contiguous and prevents the formation of artifacts in the output beam.

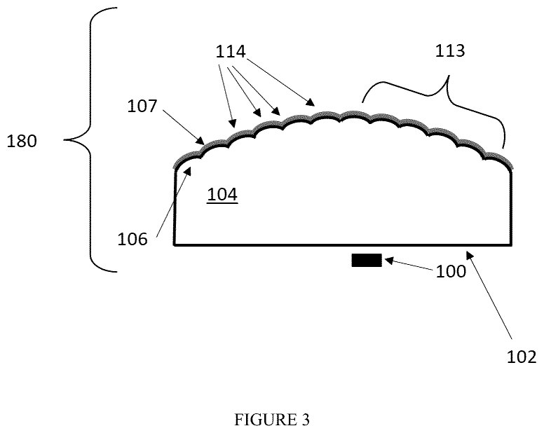

A second method of designing the reflective lens 180 to blend, enlarge, or shape the source illumination into a uniform projected beam is by applying some prescribed texture 113 to the rear face profile 106, as shown in FIG. 3. This texture represents a distribution of surface angle deviations which is imposed onto the smooth imaging formula. The texture may be comprised of surface features such as spherical cap lenslets, conic, aspheric or freeform lenslets, undulations, or other features. If lenslet features are used, they may be concave or convex. The lenslets may have sharp or rounded interfaces where they meet, or may be separated by smooth areas. The reflective coating 107 is conformal to the texture 113. A preferred embodiment is spherical cap lenslets with lenslet pitch between 1% and 10% of the diameter of the lens face 102, and focal length of the spherical cap between 0.1 and 0.5 times the focal length of the rear face profile 106.

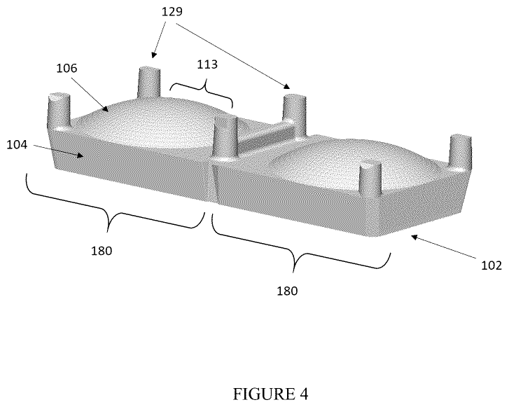

FIG. 4 is a perspective view of an example reflective lens with convex spherical cap lenslets as it might be implemented for use in a lighting product. This optic is a single piece 104 that combines two reflective lenses 180 in a side-by-side array, and is intended to be matched with a corresponding array of light sources. The two lenses share a common front face 102 and their back faces 106 feature spherical cap lenslet surface texture 113. The part also contains pins 129 and other mechanical features for alignment and retention in the lighting fixture.

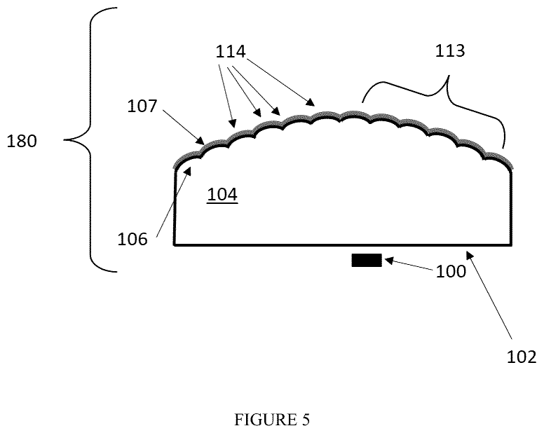

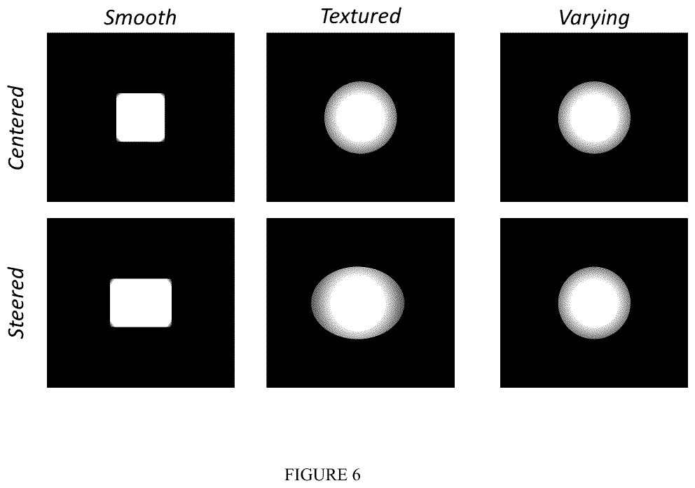

The distribution of surface angle deviations that characterizes the texture 113 may be consistent across the surface of the rear optical face 106, as in FIG. 3, or may vary in some prescribed way. In the latter case, the varying distribution of surface angle deviations may also be different in the direction parallel with the radius from the optical axis and tangential to the radius from the optical axis. In the example of FIG. 5, the surface texture is altered by reducing the surface angle deviations in the radial direction with increasing distance from the central axis 105 of the reflective imaging optic. In this example, this surface texture alteration is achieved by reducing the curvature of the lenslets 114 further from the optical axis 105. Such a design can compensate for beam expansion resulting from coma aberrations occurring as the source is displaced from the central axis of the optic. FIG. 6 depicts what typical beam profiles would look like for both steered and unsteered cases of smooth, uniformly textured, and radially decreasing texture distributions for one typical reflective steerable optic.

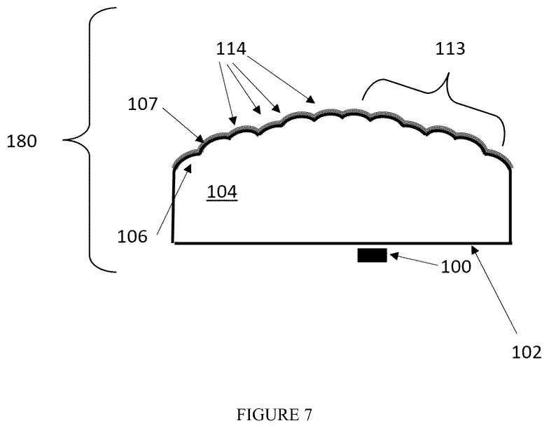

The texture 113 may be formed of regular repeated features in an array, such as the radially-packed spherical cap lenslets 114 shown in FIG. 3. Alternatively, the arrangement of the features may be in some regular grid, such as square, rectangular, or hexagonal lattices. The lattice parameters that define the placement of each texture element may be constant, producing a regular grid, or they may vary across the textured surface, producing regions with more tightly packed texture elements and regions with less densely packed elements. This packing variation may be used, alone or in conjunction with variable texture element curvature or surface angles, to change the imparted beam diffusion over steering. This variable affect over steering can be used to shape the beam or to compensate for aberration to produce a consistent beam profile over steering. Additionally, the position of the features may be “randomized” by introducing a pseudo-random perturbation of the feature positions in order to prevent structured artifacts in the output light beam that can result from a regular array of textured features. A randomly-perturbed distribution of spherical cap lenslets is shown in the example lens of FIG. 7. In this example, all lenslets have the same radius of curvature but are not positioned in a regular lattice. As a result, the edges of the lenslets are irregularly spaced and the lenslet sag varies across the array. Alternatively, the texture 113 may be comprised of lenslets with varying curvature, or by random or semi-random surface undulations that exhibit the desired surface angle distribution.

### 2. Doublet SSR Lens

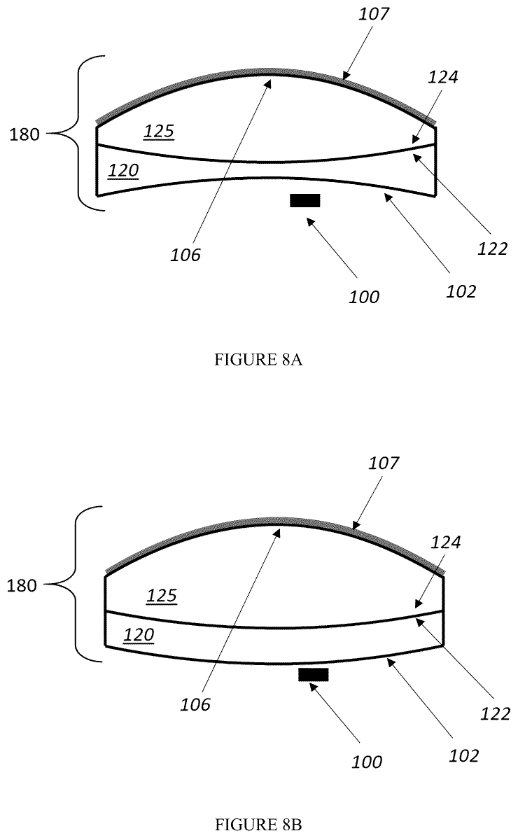

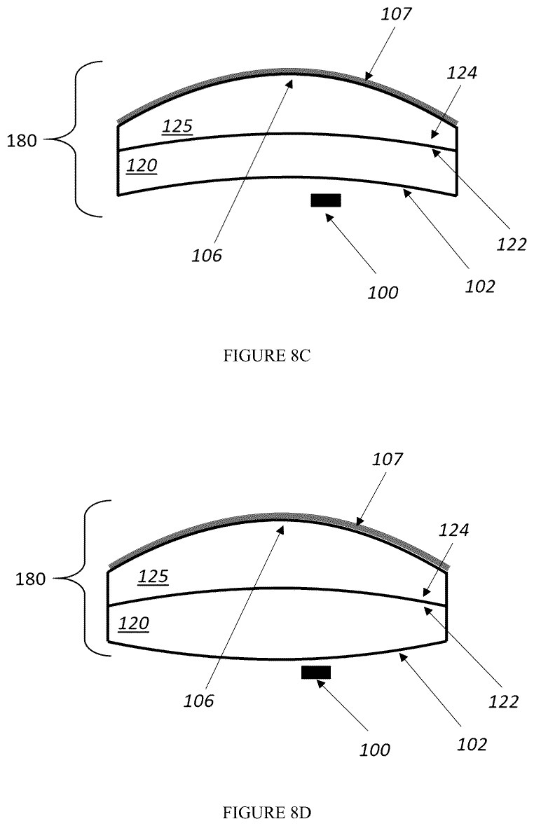

Another challenge for reflective steerable imaging optics in luminaires is color separation in the projected beam. Reflection of the light cone into a collimated beam is an achromatic process, however when the collimated beam of white light refracts from within the solid optic into ambient air, the spatially overlapping spectral components acquire slightly different angles, resulting in a blue leading edge and a red trailing edge of the beam. A method to reduce this color separation involves constructing the solid reflective optic from two different transparent materials disposed adjacent to one another, creating an additional refractive interface between them, and applying optical power at that interface. FIG. 8 depicts four configurations of this reflective doublet, with two lens elements, referenced herein as the first element 120 and the second element 125. The first element 120 has a front face 102 and junction face 122. The second element 125 has a junction face 124 and a rear face 106. The junction face 122 of the first element and the junction face 124 of the second element have opposite curvature so that they may fit snugly together. Wavelength dependent refraction that occurs at the interface where the junction faces 122 and 124 meet can be engineered to correct or obscure the chromatic separation of the projected beam. Depending on the spatial and angular uniformity of the light emitting source 100, as well as the texturing of the rear face 106, it may be advantageous to have either positive or negative curvature of the first element at one or both the front face 102 and the junction face 122. For a spatially and angularly uniform source, it is found to be advantageous for the first element 120 to be made from a material with a higher index of refraction and lower Abbe number than the second element 125, and for both refractive faces of the first element (102 and 122) to contain negative curvature (concave) as shown in FIG. 8A. For other source qualities it may be desirable for one or both of the refractive faces of the first element (102 and 122) to exhibit positive (convex) curvature. FIG. 8B shows an example in which the first element 120 is a meniscus lens with positive curvature over the source 100. FIG. 8C shows an example in which the first element 120 is a meniscus lens with negative curvature over the source 100. FIG. 8D shows an example in which the first element 120 is a double-convex lens. A further possibility is for the entry face 102 of the first element 120 to be plano, with the junction face 122 exhibiting either positive or negative curvature.

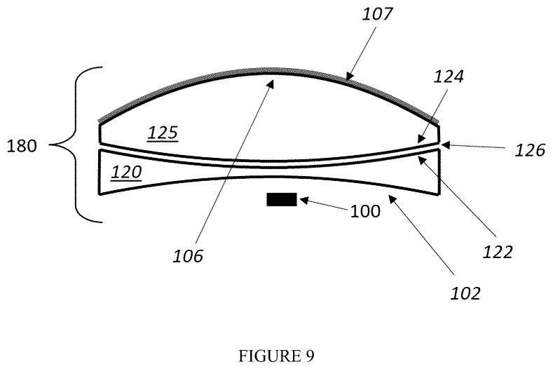

The reflective doublet lens may be constructed by over-molding one material upon another, resulting in an abrupt refractive interface where the two junction faces 122 and 124 meet. Alternatively, it may be constructed by cementing or adhering the first element 120 and second element 125 with a suitable index matching or intermediate index adhesive. In some applications it may be advantageous to leave an air gap between the first element 120 and second element 125 to reduce coma aberration at very high (>45°) steering angles, as depicted in FIG. 9.

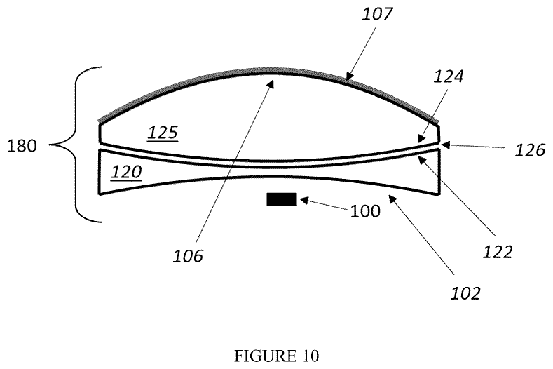

Another embodiment of the reflective doublet lens is depicted in FIG. 10, featuring surface texture for beam blending, mixing, enlarging, or shaping on the rear face 106 of the second element 125. As described above, this texture may be uniform across the surface or vary across the surface. Also, as described above, the texture features may be flat facets, repeating shapes, or random or semi-random surface undulations to provide the desired distribution of surface angle deviations for various beam steering angles.

For all the embodiments described in this section, a reflective coating may be applied to the rear face 106 in order to create reflective doublet lenses.

### 3. FSR

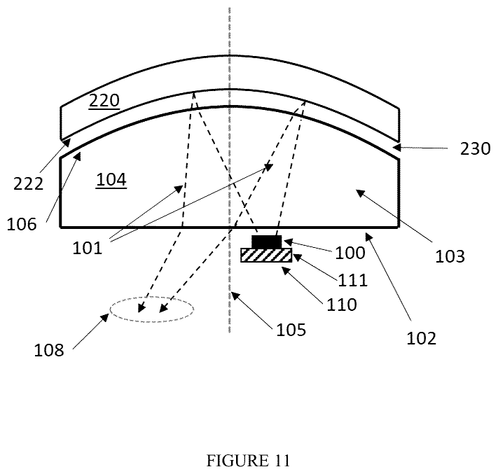

An alternative construction is shown in FIG. 11. In this case, there is no coating on the surface of the solid optic 104, but instead a separate first-surface-reflector (FSR) part 220 is disposed in close proximity to and spaced apart from the lens. The optical face 222 of the FSR 220 may be separated from the rear face 106 of the solid optic 104 by a small air gap 230. The optical face 222 of the FSR part 220 features an overall curvature that conforms to the overall curvature of the rear face 106, so that the air gap 230 is approximately constant in thickness across the surface of the lens. The thickness of the airgap 230 is preferably less than 10% of the minimum distance between the front face 102 and the rear face 106 of the solid optic 104, and most preferably less than 2% of this distance in order to maintain well-collimated output beam 108. The optical face 222 of the FSR 220 has high specular reflectivity, preferably above 80% and most preferably above 90%.

As shown in FIG. 11, most light 101 from the light source 100 enters the front face 102 of the solid optic 104, transits the interior 103, exits the rear face 106, traverses the air gap 230, reflects off the optical face 222 of the FSR part, crosses the air gap 230 once again, enters the rear face of the optic 106, re-crosses the optic interior 103, and then exits the optic front face 102 in order to form the output beam 108. A small portion of the light will undergo Fresnel reflection at the rear face 106 of the optic 104 and therefore not interact with the FSR part 220, but will still contribute to the total output beam 108.

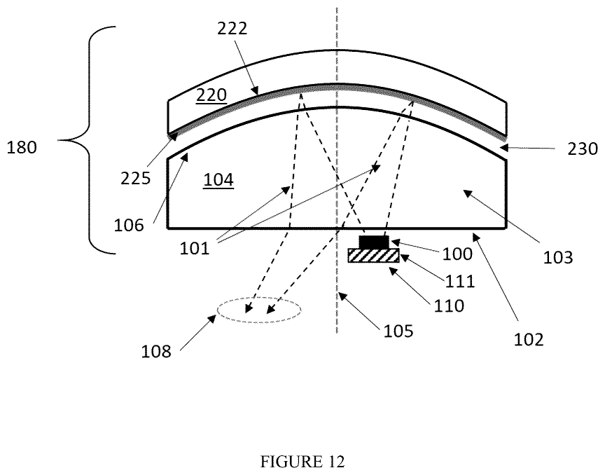

The FSR 220 may be made of a metal such as aluminum or steel with a highly polished surface on the optical face 222 to provide reflectivity. Alternatively, as shown in FIG. 12, the FSR 220 may include a high-reflectivity coating 225 applied to the optical face 222. In this case, the FSR part 220 may be made of various different materials including metal, polymer materials, or other materials.

The FSR designs provide similar optical functionality to the lens design of prior art, but offer a useful practical advantage by allowing the specular reflector to be deposited upon a different material than that used for the optic 104. This allows each material to be optimized separately for best optical performance and lowest cost, rather than forcing a compromise in these properties.

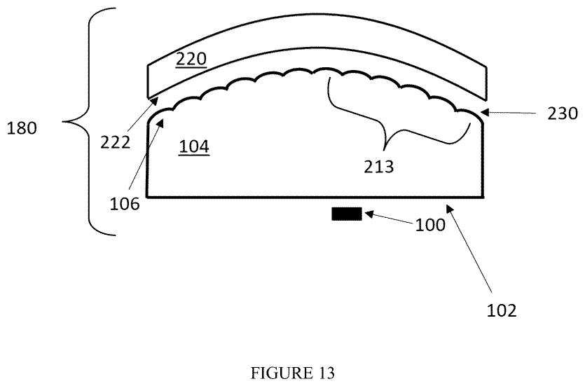

The designs shown in FIG. 11 and FIG. 12 feature a smooth rear face 106 and FSR optical face 222. Other designs are possible, however, and may be advantageous for certain implementations. For example, the rear face 106 may include textured features 213 such as the facets, lenslets, and other textures described in section 1 above. FIG. 13 shows an example in which a lenslet texture is applied to the rear face 106 and paired with a smooth FSR optical face 222. These features will provide the same type of optical benefits for beam mixing, shaping, and expanding when used with an FSR in place of a second-surface reflective coating on the lens. In this case, the surface texture mixes light by refraction of light at the varying surface angles of the textured surface. Since refraction provides less beam angle change than reflection, a more pronounced surface texture (larger surface angle variations) is required in an FSR design compared to an SSR design in order to achieve the same desired optical power specified in section 1.

While FIG. 13 shows an example that uses radially-packed uniform spherical lenslets on the rear face 106 of the lens 104, all of the embodiments in section 1 can also be applied to an FSR system. Specific embodiments include an FSR 220 and a lens 104 with a rear face 106 that features any of a faceted texture; spherical, conic, or freeform lenslet caps, undulations, or other surface textures. In further embodiments, the surface texture on the rear lens face 106 may vary with radial position on the rear face, and the surface texture may be randomly perturbed from a regularly packed array.

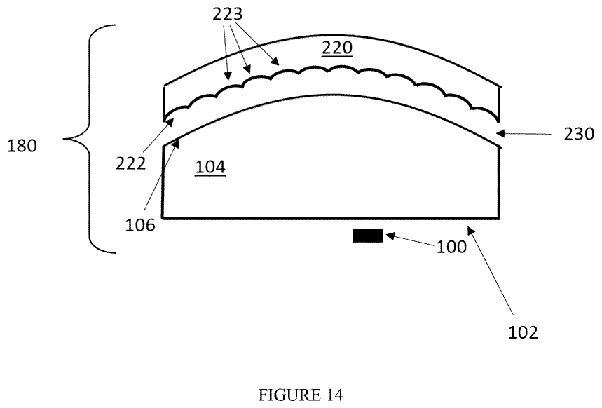

FIG. 14 shows an alternative design in which texture elements are placed on the optical face 222 of the FSR 220. FIG. 14 shows an FSR with an array of concave lenslet features 223 on the optical face 222. Other embodiments include convex lenslets, faceted texture, undulations, and other surface texture on the optical face 222. In further embodiments, the surface texture on the optical face 222 may vary with radial position on the optical face, and the surface texture may be randomly perturbed from a regularly packed array. In still further embodiments, any of these textured surfaces for the FSR may be combined with any textured surface on the rear lens face 106.

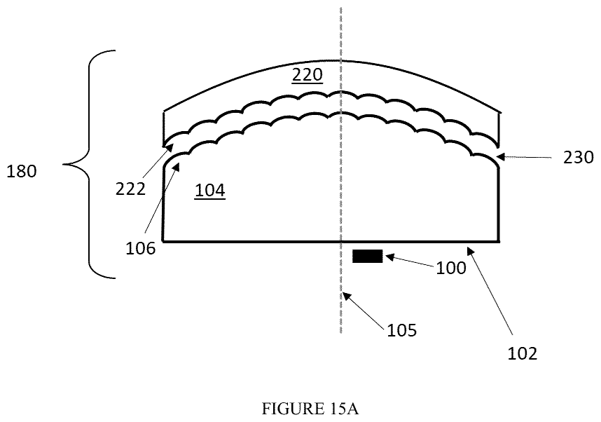

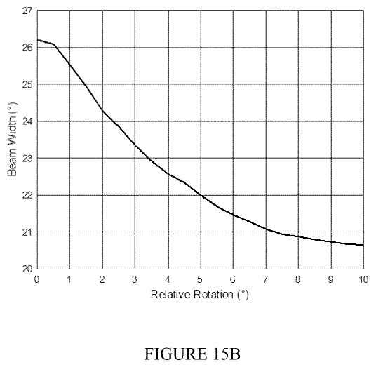

FIG. 15A shows another embodiment, in which the reflective lens 180 comprises a lenticular optical pair consisting of a lens 104 with a textured rear surface 106 and an FSR 220 with a textured optical face 222. The textures on the rear lens face 106 and the FSR optical face 222 may be convex or concave lenslets, faceted textures, undulations, or other. In this “lenticular” embodiment the two textured surfaces may be designed such that a relative rotation about their common optical axis 105 alters their interaction and changes the combined resulting spread of the light beam. This results from the texture elements on the two adjacent surfaces acting in series to either increase the imparted angular spread, or counteracting each other to reduce the imparted angular spread. The arrangement of the surface texture on the rear lens face 106 and the FSR optical face 222 may match each other. In the example shown in FIG. 15A, the rear lens face 106 features an arrangement of convex lenslets, with the FSR optical face 222 featuring a matching arrangement of concave features. Alternatively, the faces may exhibit texture layouts that differ in size or pitch. The layout of either texture may be uniform in pitch, or may vary radially and/or circumferentially along the relevant surfaces. FIG. 15B shows an example of beam width vs. relative rotation obtained from optical simulation of an example lenticular pair back-firing optical system.

A lenticular pair may be implemented in various ways. An adjustment mechanism may be provided to allow the FSR 220 to be rotated relative to the lens 104 about their common optical axis to provide adjustable beam width. Mechanical features may be provided that allow the lens 104 and FSR 220 to be clipped together in various fixed orientations to provide various fixed beam widths. Further, lenticular pairs may be designed to provide beam width variation by other forms of relative motion between the lens 104 and the FSR 220, rather than rotation about their common optical axis. For example, the beam width variation may be accomplished via relative translation of the lens 104 and the FSR 220, or via relative rotation about the approximate center of curvature of the lens surface 106 and/or the FSR surface 222.

Any of the FSR embodiments described in this section may also be combined with any of the doublet lens designs described in section 2 by replacing the reflective coating 107 with a FSR implementation.

### 4. Antireflective Surface

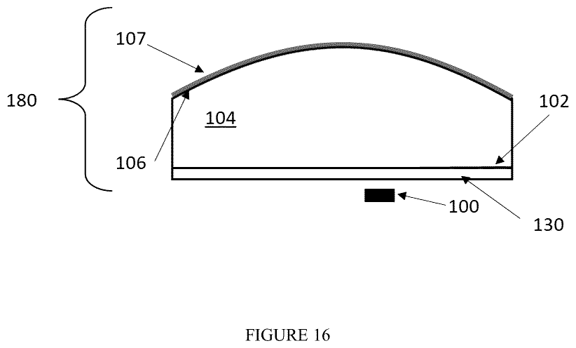

FIG. 16 shows a reflective lens 180 with an antireflective layer 130 disposed on the input face 102 of the lens. This antireflective layer reduces Fresnel reflections at the lens face 102 for light both entering and exiting the lens, improving the optical efficiency of the optical system and reducing unwanted stray light. The antireflective coating may be of any type known in the art, including motheye-type nanostructures, low-index films, porous materials, gradient index materials, or multilayer dielectric materials, and may be deposited or formed upon the lens 104 using a variety of processes including vacuum deposition, solution deposition, embossing/nanoimprinting, and more. Further, the antireflective layer 130 may be a film with a surface antireflective layer that is adhered onto the lens face 102.

The example of FIG. 16 shows the antireflective coating 130 implemented on a reflective lens 180 that is a smooth singlet SSR, but it may also be implemented with any of the reflective lens designs described in this document.

### 5. Compact Collimators

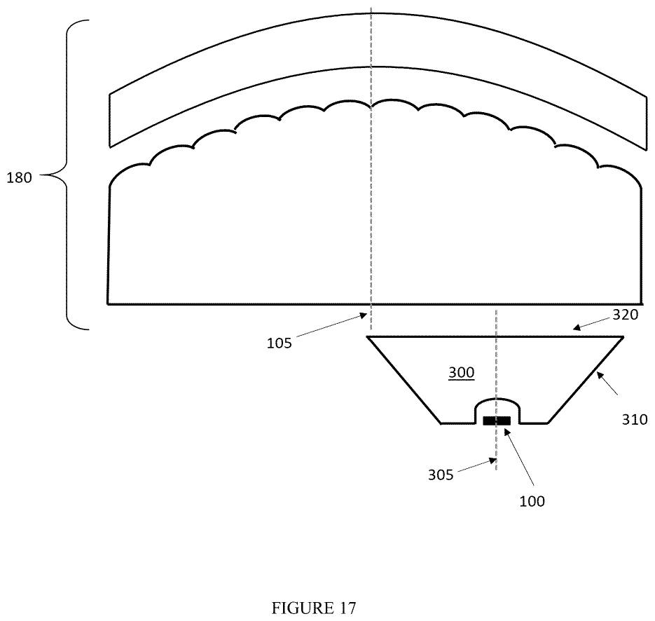

FIG. 17 shows a backfiring optical system including a compact collimating optic 300. The collimating optic 300 is comprised of a solid transparent material and surrounds the light-emitting face and sidewalls of the light source 100. The sidewalls 310 of the optic 300 slope outward and reflect light internally within the optic through either total internal reflection or applied reflective coatings. The collimating optic modestly reduces the divergence of the light cone within the solid body such that the portion of light emitted from the exit face 320 of the optic 300 at high angles (>75° from the optical axis) is reduced or eliminated compared to the portion of light emitted at such angles from the light source 100. The collimating optic 300 and light source 100 remain fixed in position relative to each other, and optical axis 305 of the collimator is maintained parallel, or nearly parallel, to optical axis 105 of the reflective lens 180. The relative position of the focusing lens collimating optic 300 and light source 100 are positioned together in the plane perpendicular to the optical axes 105 and 305 in order to steer the output beam. The beam width and shape may be further adjusted by changing the separation between the collimator and the reflective lens 180 in the direction parallel to the optical axes 105 and 305. The inclusion of the collimating optic 300 can permit more of the light from the source 100 to be directed into the reflective lens 180.

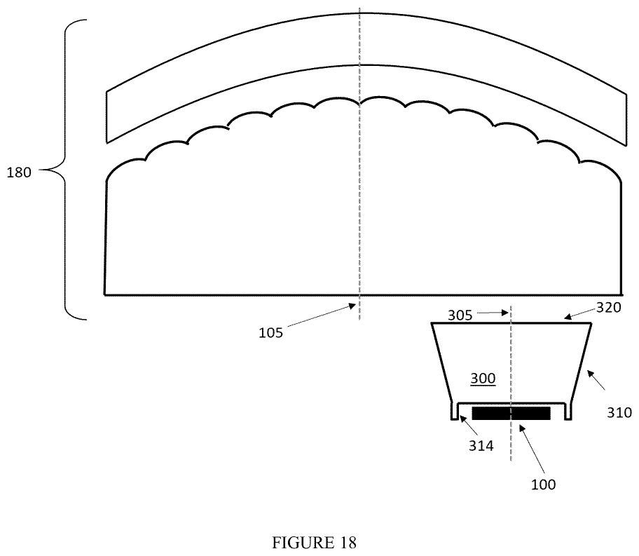

FIG. 18 shows an alternative collimator embodiment in which the optical surface 314 surrounding the sidewalls of the light source 100 is reflective, either specular or scattering, and serves to mix the high-angle light from the light source before it enters the entry face 316 of the collimator. The collimators of both FIG. 17 and FIG. 18 are shown with plano exit faces 320 but these faces could also be shaped to impart further optical function. For example, the faces 320 might feature convex curvature in order to add further collimating power. The faces 320 could also be created with concentric facet features to create a focusing Fresnel lens. Further, the faces 320 could feature texturing such as facets or lenslets to provide beam mixing.

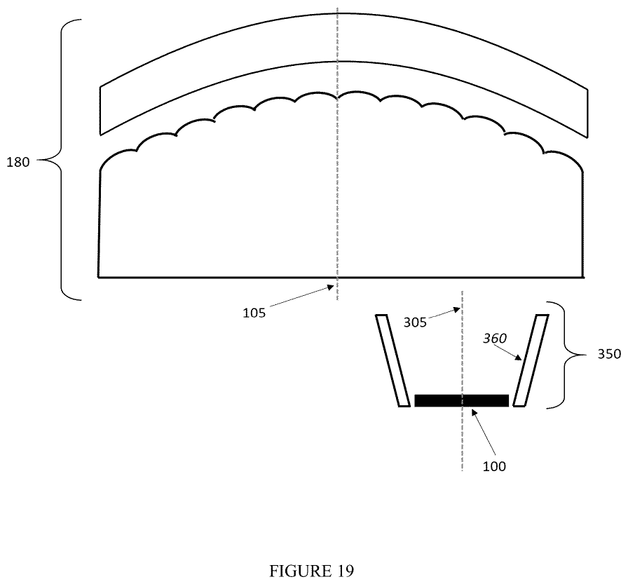

FIG. 19 shows another embodiment of a compact collimator for use with a backfiring optical system. In this design, the compact collimator 350 is a hollow optic with reflective walls 360 facing the light source. The walls 360 are sloped or curved outward in accordance with non-imaging design principles to restrict the emission of high angle light from the output 370 by imparting reflections to light emitted at high angles (>75°) from the optical axis. The reflective walls 360 may be specular or scattering, with low efficiency loss because they are designed to interact primarily with light emitted from the LED at high angles relative to the optical axis.

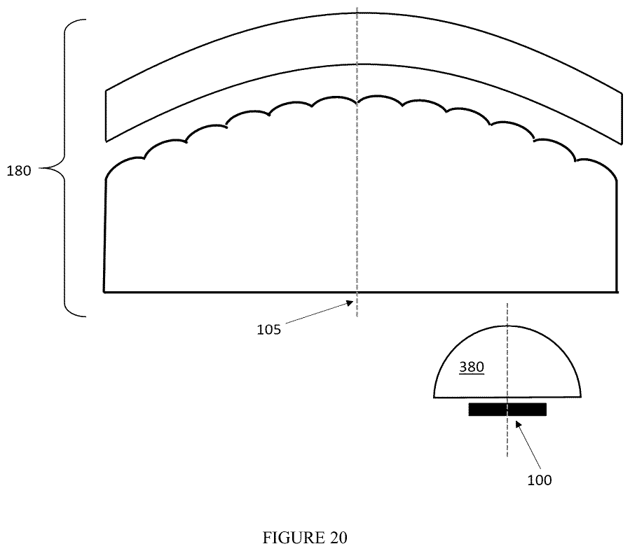

Any other type of collimator, well known in the art, may also be implemented in this system. For example, FIG. 20 shows the use of a simple plano-convex lens 380 as a collimator for the light source 100.

Note that while the example implementations shown in FIGS. 17, 18, 19, and 20 pair these collimators with a reflective lens 180 of the type shown in FIG. 13, any other embodiment of the reflective lens may also be utilized with these collimators.

### 6. Hollow Reflector

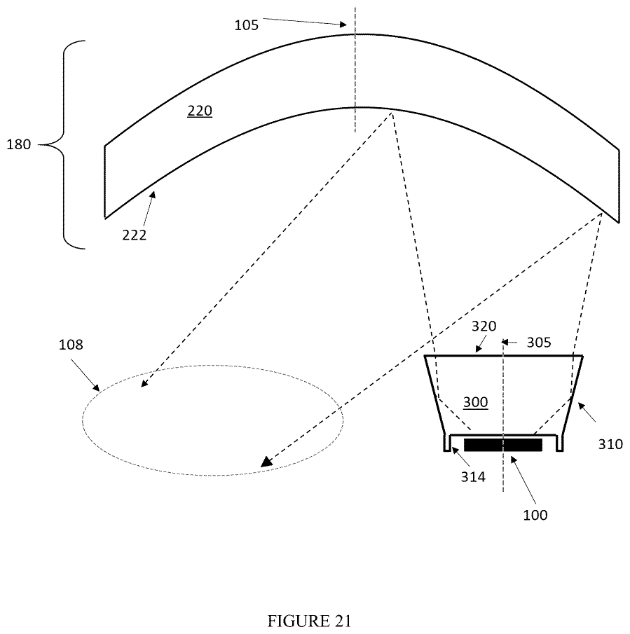

FIG. 21 shows an alternative construction in which a FSR 220 is used alone to form a hollow reflector optic. Light from the light source 100 passes through the collimating optic 300 which reduces the divergence of the beam from the light source. The light is then reflected off the FSR 220 to form a collimated light beam 108. As in previous embodiments, light source 100 and collimator 300 remain fixed in position relative to each other, and the angle at which the light beam 108 exits the system is adjusted by changing the position of the reflector (in this case the hollow FSR 220) relative to the light source 100 and collimator 300. This adjustment is preferably achieved by keeping the optical axes 105 and 305 parallel to each other and by adjusting the relative positioning in the plane perpendicular to these axes. The beam width and shape may be further adjusted by changing the separation between the FSR and the collimator in the direction parallel to the optical axes 105 and 305.

The example of FIG. 21 uses the collimator design of FIG. 18, but it may also be implemented with a wide variety of collimator types, including any of the collimators described in section 5. The design may further be implemented without any collimator at all, so that the light source shines directly into the FSR, especially if the light source has a native emission pattern that is already at least partially collimated.

### 7. Optical Design of Support Structure

Optical impacts result from the support structure 110 obscuring a portion of the output beam 108. Shadowing by the support structure results in lost light, substantially reducing the optical efficiency of the system. In addition, when the support structure is brightly lit by the output beam 108 it will be imaged in the optical system and projected as part of the output beam, altering the shape of the output beam. Finally, the sidewalls 111 of the support structure 110 can reflect and scatter light in the output beam 108. This section relates to controlling the optical properties of the support structure in order to improve beam properties.

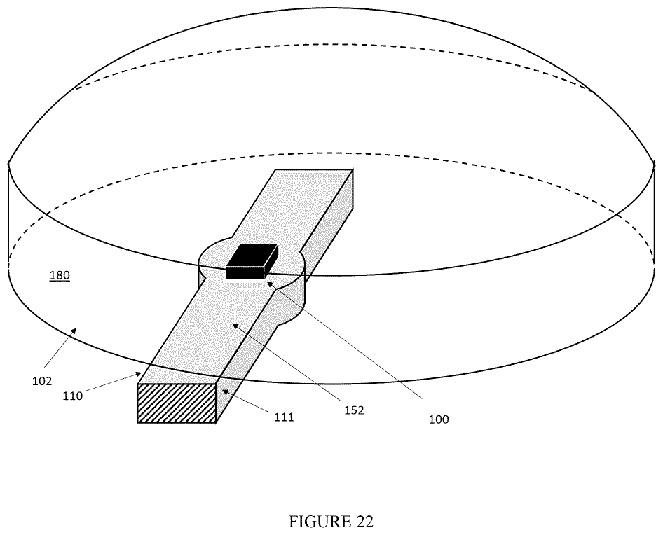

FIG. 22 shows an example support structure 110 shaped as an arm that crosses the front face 102 of the reflective lens 180. Other shapes of the support structure are possible. The support structure 110 may optionally be formed of a metal-core printed circuit board. In order to prevent beam artifacts from imaging of the brightly-lit support structure, a light-absorbing surface is provided on the face 152 of the support structure 110 that is oriented toward the front face 102 of the reflective lens 180. Such a surface will minimize the amount of light reflected back into the front face 102 of the reflective lens 180, reducing the extent to which the support structure 110 is imaged in the output beam. The light-absorbing surface on the face 152 may be provided through the use of dark paints or other colorants. The surface preferably also has a matte surface to minimize specular reflection of light from the output beam 108 back into the optic 104. If the support structure 110 is formed of a printed circuit board, then the coloring of the face 152 can be optionally provided through the use of an appropriate dark (e.g. matte black) soldermask layer.

The support structure may also feature sidewalls 111 that can reflect or scatter light in undesired directions. A further embodiment is to coat these sidewalls with a light-absorbing structure in order to minimize such undesired light. In the case where the support structure is a circuit board with an aluminum core, a convenient method for providing such a light-absorbing sidewall coating is to create a black anodized surface finish on the exposed aluminum sidewalls 111 of the circuit board.

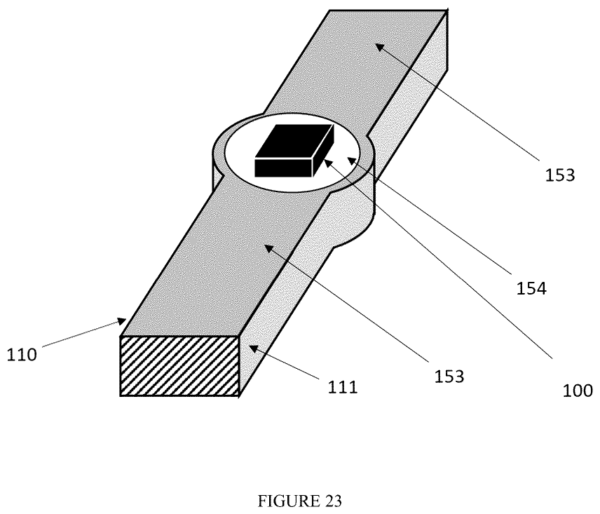

FIG. 23 shows a support structure design in which the area 154 near the light source 100 on the face 152 of the support structure 110 is made to be reflective instead of light-absorbing. The area 153 of the face 152 that is not near the light source 100 is still made to be light-absorbing. Light from the output beam that strikes the reflective area 154 will be reflected back into the optic 104 and will ultimately contribute to the output beam. The reflective area 154 therefore improves the system efficacy compared to using only light-absorbing surfaces on the face 112. Because the reflective area 154 is near the light source 100, light from this area does not substantially change the shape of the output beam. The extent to which the reflective area 154 extends away from the light source 100 may be tailored depending upon the degree of mixing and beam expansion within the optical system and the desired end beam-width, but is preferably between 0.05 and 3 times the characteristic dimension of the light source 100. The reflective area 154 may provide a scattering reflection or a specular reflection or a mixture of the two. In this embodiment, the reflective area 154 provides an approximately consistent reflectivity across the spectrum of the light source 100. The reflective surface may be produced, for example, using a white paint or other high-reflectivity coating. If the support structure 110 is formed of a printed circuit board, then the areas 153 and 154 may be provided by using a dark soldermask layer with a reflective (e.g. white) “silkscreen” layer printed on it only in the area 154; alternatively, it may be produced using a reflective soldermask layer with a dark (e.g. black) “silkscreen” layer printed on it only in the area 153. The shape of the reflective area 154 may be tailored to impact the shape of the output beam 108, and the local reflectivity of the area may also be tailored by controlling the composition or density of the reflective material.

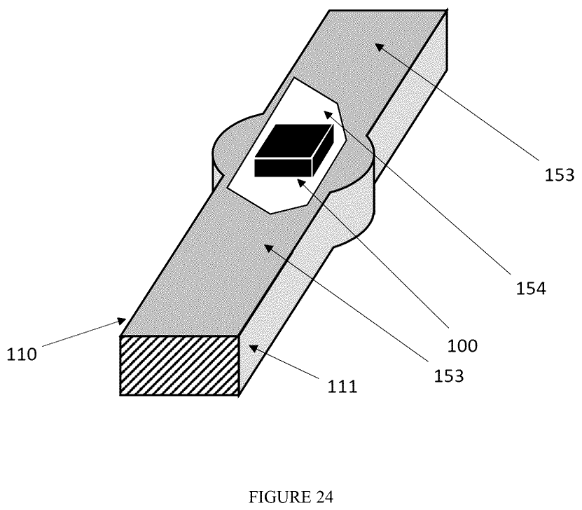

FIG. 24 shows an embodiment where the reflective area 154 of the support structure 110 is shaped in order to impart a change in the intensity distribution of the far field beam. This area could be shaped to provide enhanced flux to the outskirts of the beam, or to adjust the gradient of the beam in order to blend two beams more smoothly. Alternatively, the reflective area 154 may be shaped to impart a structure into the beam that projects desirably onto a surface, for instance a trapezoidal reflective area can be used to project more even illuminance on a vertical surface on which the beam is aimed. This reflective area 154 may be uniformly reflective or exhibit a gradient for even greater control over the projected beam. The support structure 110 may be enlarged to accommodate a desired reflective area 154.

In another embodiment, the area 154 is produced with a specific desired reflectivity spectrum. This produces a shift the spectrum of the output beam 108. For example, if the area 154 is blue in color (reflecting blue light and absorbing other colors), it will preferentially reflect blue light back into the optic 104 and therefore shift the entire output beam 108 to be more blue in color. This may be desired in order to achieve a specific color point for a light fixture, or to compensate for spectral impact resulting from other elements of the optical system. The color of the reflective material in area 154 may be controlled by appropriately specifying the paint or other reflective coating to be applied. The color intensity may be controlled by choosing the tint of the paint, or by using a dither pattern (“halftone”) including dots of broad-spectrum (e.g. white) reflective material and colored reflective material. If the support structure 110 is formed of a printed circuit board, then the board may preferably be formed using a dark soldermask layer to provide a light absorbing material in area 153 with a colored “silkscreen” layer printed on it only in the area 154.

The designs in this section may be applied with any back-firing optical system, including those described in the previous sections or of prior art, and including the various reflective lens embodiments and with or without the use of a collimator and/or FSR.

### 8. Array Designs

A lighting system may be comprised of an array of back-firing optical systems, where the back-firing optical systems may be of any design including those described in the previous sections or of prior art, and including the various reflector and reflective lens embodiments and with or without the use of a collimator. The array may contain any number of back-firing optical systems, including even a single back-firing optical system. Each back-firing optical system includes at least one light source and at least one optical element, so that the lighting system comprises an array of light sources and a corresponding array of optical elements. The output beam from each of the back-firing optical systems, together, form the aggregate optical output of the lighting system.

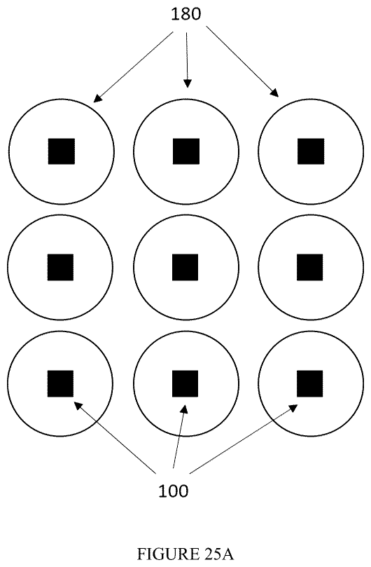

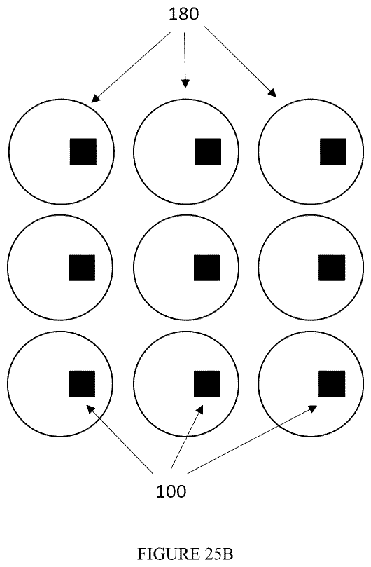

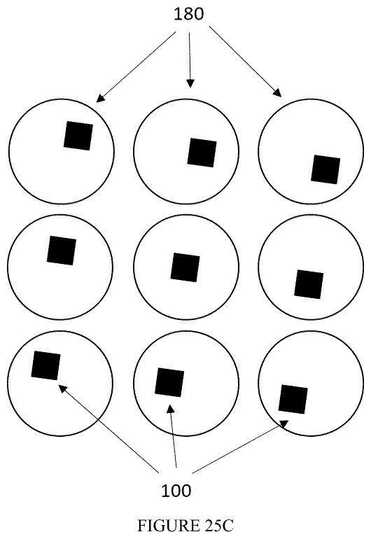

In one embodiment, the arrangement of the light sources in the light source array is fixed and matches the similarly fixed arrangement of optical elements in the optical element array. The array of optical elements may optionally be moved relative to the array of light sources, in the plane of the arrays, via an adjuster mechanism. Such movements permit the beam to be steered. FIGS. 25A to 25C show a plan view of such a system, viewed in a direction parallel to the optical axes 105 of the reflective lenses 180, showing only the positions of the reflective lenses 180 and the sources 100. In FIG. 25A, the light sources 100 are all positioned along the optical axes of the optical elements, resulting in output beams that are parallel to the optical axes. In FIG. 25B, the arrays have been moved so that the light sources 100 are all offset from the optical axes 105 of the optical elements, resulting in output beams that are steered away from the optical axes 105. In FIG. 25C, the arrays have been rotated relative to one another, resulting in output beams that are spread over a range of angles, producing a wider aggregate optical output beam.

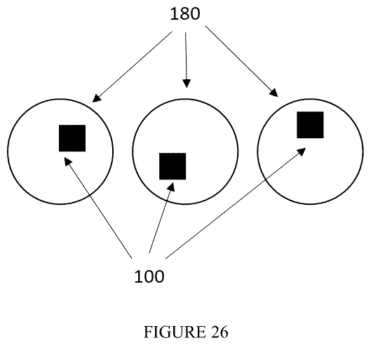

In a second embodiment, as shown in the example of FIG. 26, the fixed arrangement of the light sources 100 in the light source array does not match the fixed arrangement of reflective lenses 180 in the optical element array. As a result, the light beams emerging from each reflective lens 180 are not all aimed in the same direction. The aggregate optical output beam created by the combination of the different output beams from the different back-firing optical systems may take on a complex structure by appropriate design of the two arrays. The two arrays may be fixed in position relative to one another in order to produce a static aggregate output beam, or may be configured to move relative to one another in order to permit the aggregate output beam to be steered and/or broadened.

In yet another embodiment, the arrangement of optical elements 180 and/or the arrangement of light sources 100 is not fixed, so that the direction of the light beam from individual reflective lenses 180 (or groups of reflective lenses 180 if groups are held in a fixed arrangement) can be aimed by adjusting the positioning of the optical element (or group of optical elements) relative to the individual light sources 100 (or group of light sources).

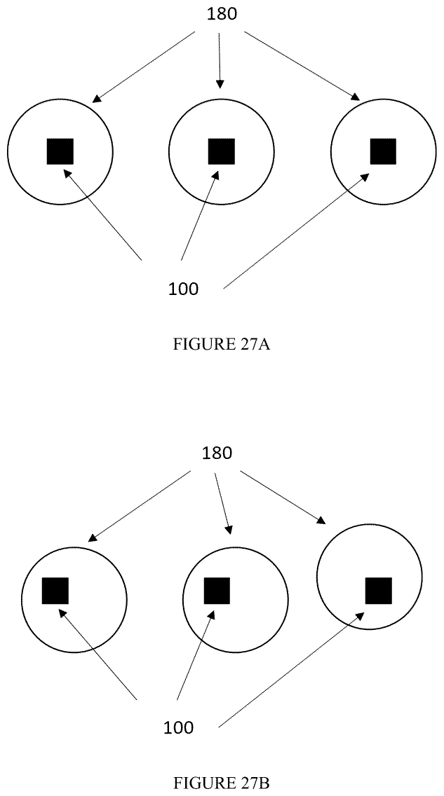

FIG. 27 shows an example of such a system, in which three reflective lenses 180 may be adjusted independently relative to three light sources 100, producing three independently aimable beams. FIG. 27A shows the configuration in which all three beams emerge parallel to the optical axes of the optical elements, and FIG. 27B shows a configuration in which two of the beams have been aimed in one direction and one beam aimed in a different direction. The system may be realized via movement of the optical elements and/or movement of the light sources.

These examples are not exhaustive, and other useful implementations of these optics within lighting systems will be evident to those skilled in the art.

1. A back-firing optical system comprising:
a light source,
a lens having an entry face and a back face,
a surface reflector,
wherein the surface reflector is disposed in close proximity to the lens, and spaced apart from the back face of the lens by an air gap, and
wherein the surface reflector features an overall curvature that conforms to an overall curvature of the back face of the lens, and
a support structure, configured to support the light source in a location that necessarily obscures a portion of the entry face of the lens, with the support structure further configured for reducing an extent to which the support structure interferes with an output beam.

2. The system of claim 1 wherein the support structure further comprises a light-absorptive surface provided on a portion of a face of the support structure that orients towards the entry face of the lens.

3. The system of claim 2 wherein the light-absorptive surface of the support structure further comprises a dark paint or other dark colorant.

4. The system of claim 2 wherein the support structure comprises a circuit board and the light-absorptive surface is a dark solder mask layer of the circuit board

5. The system of claim 1 wherein the support structure further comprises one or more sidewalls that are light-absorptive.

6. The system of claim 2 wherein the support structure comprises a circuit board having sidewalls, the sidewalls further comprising a light-absorptive material.

7. The system of claim 6 wherein the sidewalls are coated with a black anodized material.

8. The system of claim 2 wherein an area of the support structure adjacent the light source is a light-reflective area.

9. The system of claim 8 wherein an extent of the light-reflective area adjacent the light source is determined by a desired degree of mixing or beam expansion within the system.

10. The system of claim 8 wherein an extent of the light-reflective area adjacent the light source is between 0.05 and 3 times a characteristic dimension of the light source.

11. The system of claim 8 wherein the light-reflective area adjacent the light source is either light scattering or specularly reflective.

12. The system of claim 8 wherein the support structure comprises a circuit board, and the light-reflective area adjacent the light source further comprises either a white silkscreen layer disposed on a dark solder mask layer or a reflective solder mask having a black silkscreen printed thereon.

13. The system of claim 8 wherein a shape of the light-reflective area adjacent the light source is further tailored to control a shape of the output beam or a shift in a spectrum of the output beam.

14. The system of claim 8 wherein the light-reflective area has at least one of either a shape that imparts a change in an intensity distribution of an output beam or a specific reflectivity spectrum, to thereby produce a shift in a spectrum of the output beam.

15. The system of claim 1 additionally comprising a texture disposed on the back face of the lens.

16. The system of claim 1 wherein the lens and the surface reflector further form an optical element that is part of an array of optical elements.

17. The system of claim 16 wherein selected ones of the optical elements are differently oriented with respect to the light source than other ones of the optical elements.

18. The system of claim 1 additionally comprising:
an adjustment mechanism, configured to control a direction of an output beam emitted from the lens by adjusting a position of the light source relative to an optical axis of the lens within a plane perpendicular to the optical axis.

19. The system of claim 18 wherein the adjustment mechanism is further arranged for adjusting a rotation of the surface reflector relative to the lens, to thereby adjusting a width of the output beam.
